(19) United States
(12) Patent Application Publication
(10) Pub. No.: US 2026/0033669 A1
(43) Pub. Date: Feb. 5, 2026

(54) Self-Powered Food Rotational System

(71) Applicant: Harmonious International Ltd., Tsuen Wan (CN)

(72) Inventors: Alex Le-Tien Fei, Los Angeles, CA (US); Shu Hsing Wen, Hong Kong (CN); Le Chun Fei, Hong Kong (CN)

(21) Appl. No.: 19/357,015

(22) Filed: Oct. 13, 2025

Related U.S. Application Data
(63) Continuation-in-part of application No. 16/431,189, filed on Jun. 4, 2019, now Pat. No. 12,442,538.
(60) Provisional application No. 62/680,019, filed on Jun. 4, 2018.

(51) Int. Cl. A47J 37/04; A23G 9/12; A47J 37/07; F03G 1/08

(52) U.S. Cl. CPC A47J 37/041; A23G 9/12; A47J 37/043; A47J 37/046; A47J 37/047; A47J 37/0704; A47J 37/0745; A47J 37/0763; A47J 2037/0777; F03G 1/08

(57) ABSTRACT

A system and method for cooking food on a rotisserie in a conventional oven includes setting an oven thermostat to a desired cooking temperature. A spring on a mechanical drive motor is wound and a spit is placed through meat oriented horizontally or vertically. The spit is then placed on a support to hold the meat in a substantially horizontal position, and the spit is coupled to a mechanical drive motor. The oven rotisserie and meat are placed into the oven to commence a cooking operation. The spit is rotated intermittently via the mechanical drive motor during the cooking operation in accordance with operation of an escapement and gear of the mechanical drive motor. The oven rotisserie and meat are removed from the oven after completion of the cooking operation. A mechanical drive motor is also used to rotate flat foods, such as pizza, about a vertical axis.

### CROSS-REFERENCE TO RELATED APPLICATIONS

This is a continuation-in-part of U.S. patent application Ser. No. 16/431,189, entitled “Oven Rotisserie”, filed on Jun. 4, 2019, which in turn claims the benefit of U.S. Provisional Patent Application No. 62/680,019, entitled “Roto Crisper 360”, filed Jun. 4, 2018, the disclosures of each of which are hereby incorporated by reference as if set forth in their entireties herein.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND

### 1. Field of the Invention

This application relates generally to a self-powered food rotational system. In some embodiments, the self-powered food rotational system relates to rotisserie cooking. In these embodiments, the application relates more particularly to a rotisserie system configured to operate in a conventional oven, such as a convection oven.

### 2. Background

Conventional ovens cook food by exposing food surfaces to radiant, heated air over time. Convection ovens add a mechanism, such as a fan, for circulating heated air which may speed cooking time or allow use of a lower temperature setting. Baking is when food stays immobile during a cooking process. Roasting is baking at higher temperature, typically 400° F. (approximately 200° C.), or higher. Broiling is cooking via exposure of food to infrared radiation, such as placing it under an oven burner or over a bed of hot charcoals. Home ovens may provide a mechanism to bake or roast via radiant or convective heat. They may also include a broiler where food can be placed under a flame.

In all, many different types of oven cooking are available. These include:

Baking: This is the most common way to cook food in an oven. It involves placing the food in a baking dish or on a baking sheet and cooking it using dry heat.

Roasting: This is similar to baking but typically involves cooking larger cuts of meat or whole birds, such as a turkey or a chicken. The food is usually cooked at a higher temperature than baking, which helps to create a crispy exterior.

Broiling: This involves cooking food using high heat from the top of the oven. It is often used to brown the tops of dishes or to create a crispy crust on foods like fish or meats.

Grilling: This is similar to broiling, but the heat comes from below the food. This method is often used to cook foods like burgers, hot dogs, or vegetables.

Convection cooking: This is a method that uses a fan to circulate hot air around the food. It can help to cook food more evenly and can also reduce cooking times.

Steaming: This involves placing food in a covered dish with a small amount of liquid and cooking it in the oven. This method is often used to cook vegetables, fish, or other delicate foods.

Slow cooking: This involves cooking food at a low temperature for an extended period of time. It is often used to cook tough cuts of meat or to create dishes like stews or casseroles.

Dehydrating: This involves using low heat to dry out foods like fruits or vegetables to make them into snacks or for other uses.

Most home ovens typically operate to cook meats with a user placing it in a roasting pan, which may be covered, setting a desired temperature which is maintained by a thermostat, opening an oven door, inserting the roaster, closing the door and setting a timer for a specified cooking duration.

In cooking larger food items, including poultry, and particularly turkey, the food must be flipped or rotated at least once during the cooking cycle for even cooking. Flipping requires removal of the food from the oven and manually turning the bird before placing it once again in the oven to continue the cooking process.

During cooking, meats typically lose juices which accumulate at the bottom of the roaster. Additionally, during the cooking process, only the underside of the food will be exposed to these juices. Thus, the user may have to periodically remove the roaster and baste a top surface of the food to prevent it from becoming overly dry. This can be done multiple times, including during a flipping procedure. More frequent basting may improve flavor or texture, but requires substantially more user effort and a longer cooking duration due to loss of heating exposure and oven reheating.

### BRIEF SUMMARY

Accordingly, the present invention is directed to a self-powered food rotational system that substantially obviates one or more problems resulting from the limitations and deficiencies of the related art.

In accordance with one or more embodiments of the present invention, there is provided a self-powered food rotational system that includes a support assembly; a food rotational member having a rotational axis, the food rotational member configured to rotate an associated food item; a mechanical drive motor operatively coupled to one end of the food rotational member, the mechanical drive motor configured to impart a rotational force to the food rotational member via a gear; and the mechanical drive motor configured to be powered by a manually wound spring.

In a further embodiment of the present invention, the support assembly comprises a first support and a second support, and the food rotational member is pivotably secured between the first support and the second support.

In yet a further embodiment, the system further comprises a horizontal base pivotally connected to the first and second supports at opposite ends configured such that both the first and second supports are inwardly foldable toward one another.

In still a further embodiment, the food rotational member comprises a food support in a form of a removable spit pivotably secured to the first and second supports at distal ends thereof.

In yet a further embodiment, the spit is comprised of two or more parallel skewers.

In still a further embodiment, the system further comprises a drip tray disposed between the first support and the second support.

In yet a further embodiment, the food rotational member comprises a food support that includes a cylindrical cage pivotably secured to the first and second supports.

In still a further embodiment, the food support further comprises oppositely disposed perforate end panels.

In yet a further embodiment, the food support further comprises a latchable door.

In still a further embodiment, the support assembly comprises a base for containing the mechanical drive motor, the mechanical drive motor including a rotatable shaft disposed in a substantially vertical orientation; and the food rotational member comprises a rotatable, substantially planar horizontal food support mechanically linked to a top end of the rotatable shaft of the mechanical drive motor.

In yet a further embodiment, the rotatable, substantially planar horizontal food support comprises a round, planar surface in contact with the rotatable shaft at a center thereof.

In still a further embodiment, the rotatable, substantially planar horizontal food support is further configured to be selectively removable from the rotatable shaft of the mechanical drive motor; and the rotatable, substantially planar horizontal food support is perforate.

In yet a further embodiment, the support assembly comprises a base for containing the mechanical drive motor, the mechanical drive motor including a rotatable shaft disposed in a substantially vertical orientation; and the food rotational member comprises a removable vertically-oriented spit pivotably mechanically linked to a top end of the rotatable shaft of the mechanical drive motor.

In still a further embodiment, the vertically-oriented spit is comprised of two or more parallel skewers.

In yet a further embodiment, the support assembly comprises a base that includes a top base support and a plurality of base legs extending from the top base support, the mechanical drive motor configured to be supported in or on the top base support, and the mechanical drive motor including a rotatable shaft disposed in a substantially vertical orientation; and the food rotational member comprises a removable vertically-oriented spit operatively linked to a bottom end of the rotatable shaft of the mechanical drive motor such that food supported on the vertically-oriented spit is capable of being rotatably suspended over an open fire.

In still a further embodiment, the support assembly comprises a base that includes an insulated housing and a top cover, the mechanical drive motor configured to be supported in or on the top cover, and the mechanical drive motor including a rotatable shaft disposed in a substantially vertical orientation; and the food rotational member comprises a vertically-oriented agitator member, the vertically-oriented agitator member being operatively linked to a bottom end of the rotatable shaft of the mechanical drive motor such that the vertically-oriented agitator member is capable of churning ice cream in the insulated housing of the base.

In yet a further embodiment, the mechanical drive motor is in a form of a heat tolerant mechanical drive motor with an audible output for alerting a user to rewind the mechanical drive motor.

In accordance with one or more other embodiments of the present invention, there is provided a self-powered food rotational system that includes a first support; a second support; a food support having a rotational axis pivotably secured between the first support and the second support, the food support configured to rotate an associated food item; a heat tolerant mechanical drive motor operatively coupled to one end of the food support, the mechanical drive motor configured to impart rotational force to the food support via a gear; and the drive motor configured to be powered by a manually wound spring.

In a further embodiment of the present invention, the first support and the second support form oppositely disposed sides of a foldable grill assembly, and the foldable grill assembly further comprises a plate member or grilling rack configured to be disposed above the food support.

In yet a further embodiment, the first support and the second support form oppositely disposed sides of a foldable grill assembly, and the foldable grill assembly further comprises a plate member configured to be disposed below the oppositely disposed sides of the foldable grill assembly so as to form a base plate for supporting charcoal.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE DRAWINGS

Various embodiments will become better understood with regard to the following description, appended claims and accompanying drawings wherein:

FIG. 1 is a perspective view of an example embodiment of an oven rotisserie comprised of a cylindrical, rotatable cooking cage;

FIG. 2 is the example embodiment of FIG. 1 showing a door open orientation;

FIG. 3 illustrates a front view of the oven rotisserie of FIGS. 1 and 2;

FIG. 4 illustrates a back view of the oven rotisserie of FIGS. 1 and 2;

FIG. 5 is a perspective view of another example embodiment of an oven rotisserie wherein food is rotated on a spit;

FIG. 6 is a cutaway view of the oven rotisserie along line 6-6 of FIG. 5;

FIG. 7 is an example embodiment of a mechanical drive motor;

FIG. 8 is an exploded view showing a spit, drip pan and drive motor of an oven rotisserie;

FIG. 9 illustrates a side view of an oven rotisserie;

FIG. 10 illustrates a top view of an oven rotisserie;

FIG. 11 illustrates a bottom view of an oven rotisserie;

FIG. 12 illustrates a side view of an oven rotisserie;

FIG. 13 illustrates another side view of an oven rotisserie;

FIG. 14 is a flowchart of an example embodiment of a cooking process using an oven rotisserie system;

FIG. 15 is a perspective view of another example embodiment of an oven rotisserie;

FIG. 16 is a perspective view of another example embodiment of an oven rotisserie;

FIG. 17 is a perspective view of an example embodiment of a system for rotating flat foods;

FIG. 18 is an exploded view of the system of FIG. 17;

FIG. 19 illustrates an example embodiment of the system of FIG. 17;

FIG. 20 is a perspective view of a system for rotating vertically oriented foods while being cooked in an oven;

FIG. 21 is an exploded view of a bottom portion of the system of FIG. 20;

FIG. 22 illustrates an example embodiment of the system of FIG. 20;

FIG. 23 is a perspective view of an example embodiment of a system for rotating vertically oriented foods over an open fire;

FIG. 24 is a perspective view of an example embodiment of an ice cream maker utilizing a mechanical drive motor;

FIG. 25 is a perspective view of an example embodiment of a foldable grill assembly utilizing a mechanical drive motor, wherein a manner in which the mechanical drive motor attaches to the foldable grill housing is depicted;

FIG. 26 is another perspective view of the foldable grill assembly of FIG. 25, wherein a grilling rack on the top of the foldable grill assembly is depicted;

FIG. 27 is yet another perspective view of the foldable grill assembly of FIG. 25, wherein a manner in which the foldable grill housing is placed on a grill base plate is shown;

FIG. 28 is still another perspective view of the foldable grill assembly of FIG. 25, wherein a manner in which the foldable grill housing is placed on an open fire is shown;

FIG. 29 is yet another perspective view of the foldable grill assembly of FIG. 25, wherein a manner in which the foldable grill housing is placed on a grate of a portable grill is shown;

FIG. 30 is still another perspective view of the foldable grill assembly of FIG. 25, wherein a manner in which a spit is inserted in the foldable grill is shown;

FIG. 31 is yet another perspective view of the foldable grill assembly of FIG. 25, wherein a manner in which a rotisserie basket is inserted in the foldable grill is shown; and

FIG. 32 is yet another perspective view of the foldable grill assembly of FIG. 25, wherein a manner in which a flatspin basket is inserted in the foldable grill is shown.

Throughout the figures, the same parts are always denoted using the same reference characters so that, as a general rule, they will only be described once.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In addition to oven cooking, as noted above, food can be cooked over an open fire, with the food being suspended over the fire by a support. The food support can include a horizontal support, which may be comprised of a spit. A spit is a long, thin rod, typically metal or wood, pushed through meat in order to hold it while it is roasted over an open fire. A rotisserie is a spit that is rotatable.

Oven cooking can be enhanced by use of a rotisserie, particularly so with one that operates continuously or continually during a cooking process. Rotating meats during the cooking process can assist to maintain juices in the meat longer to enhance flavor. Rotating meat also assures a more even exposure of a food surface to heat, such as its positioning relative to a fixed heating element such as a gas burner or electric cooking element. A rotisserie feature can be built into an oven, such as an electric, countertop rotisserie oven. This requires a user to purchase, clean, maintain and store a dedicated appliance. During use, a significant amount of counter space may be lost due to the size of the appliance. Also, cooking must be done with electricity which can be more expensive to operate than a gas oven. Additionally, a countertop appliance may not have an ability to achieve convection heating nor perform self-cleaning as can a typical home oven.

A typical home oven has no rotisserie available. Example embodiments herein provide a rotisserie system that can be used with a typical, unmodified home oven. A home oven capacity is typically between two and four cubic feet (approximately 56-113 liters). A compact oven may be between one and two cubic feet (approximately 28-56 liters). Example embodiments herein comprise rotisserie systems sized to fit with the available space of an existing homeowner's oven. Rotation is accomplished by stored, mechanical energy such as by winding of spring which can power rotation during cooking. Mechanical power is advantageous insofar as metals can have a high tolerance for high oven temperatures, unlike electrical components such as motors. Additionally, electrical power requires a power source, such as a power outlet, which is typically unavailable inside an oven. An integrated electrical power source, such as a battery, can be easily comprised, or even explode dangerously, when exposed to oven temperatures.

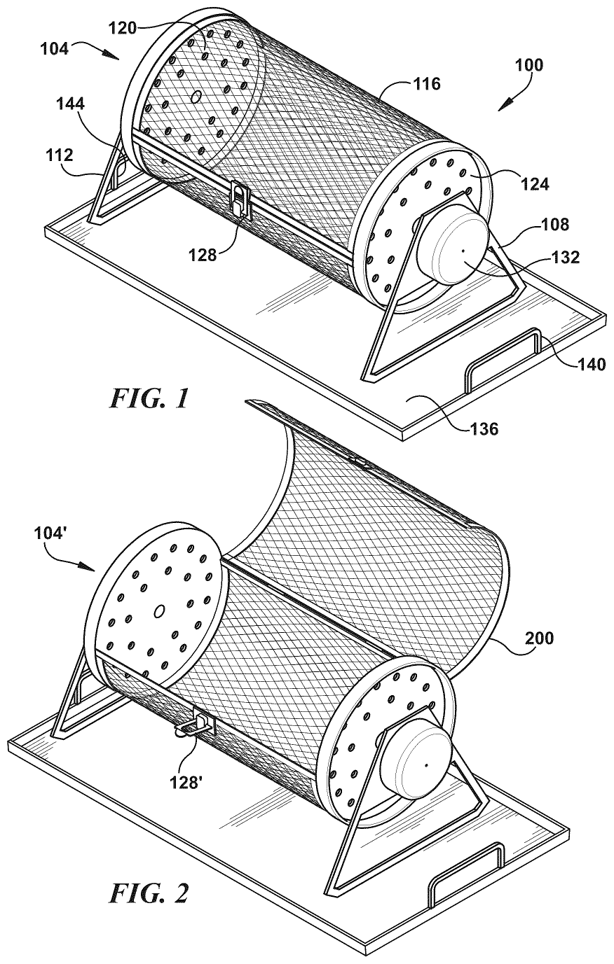

FIG. 1 illustrates an example embodiment of an oven rotisserie 100 comprised of a cylindrical, rotatable cooking cage 104 axially supported by a first support 108 and a second support 112. Cooking cage 104 includes a circumferential, porous or perforate wall 116, suitably comprised of a metal screen or mesh which allows heated air to pass through radially. Cooking cage 104 further includes circular end caps 120 and circular end cap 124, which is also perforate, such so as to allow heated air to pass through cooking cage 104 axially. With added reference to FIG. 2, it will be noted that closed latch 128 may be opened at 128′ so as to allow door 200 of cage 104 to be opened to place food in a central cavity of cooking cage 104′. Example foods include foods that are relatively small and cooked in quantity. Closing of door 200 and closing of latch 128 allows for food to be secured within cooking cage 104. Drive mechanism or motor 132, suitably comprised of a wind-able spring motor, allows for continued food rotation when oven rotisserie 100 is placed in a conventional oven. Winding is suitably accomplished by rotating an outer circumference of drive mechanism 132. Any suitable spring motor may be used as will be understood by one of ordinary skill in the art.

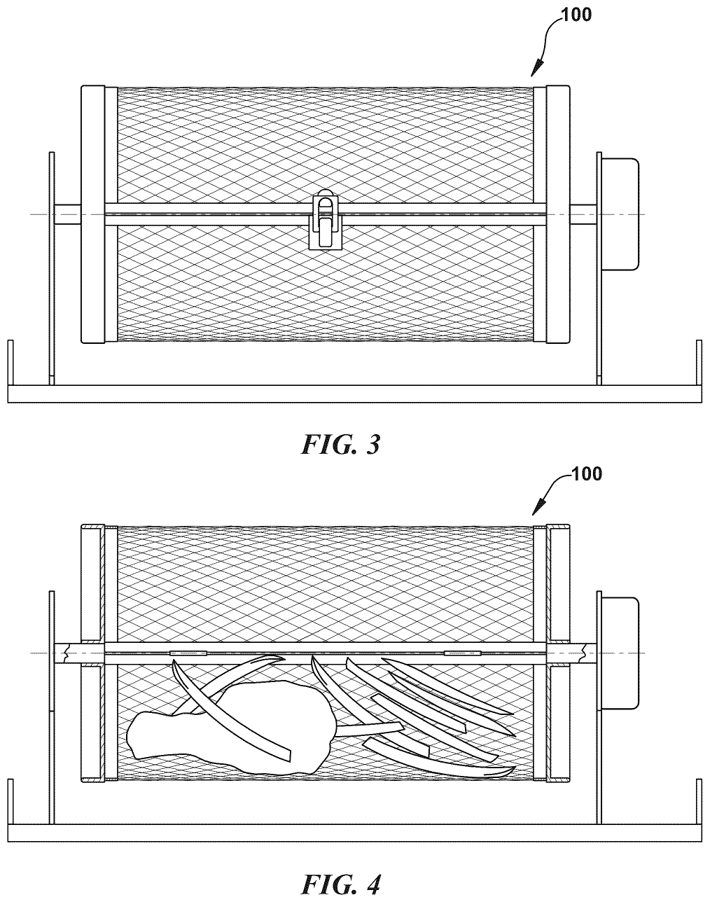

Also included in oven rotisserie 100 is drip tray 136 that services to catch crumbs or grease resultant from the cooking process. Drip tray 136 includes first and second handles 140 and 144 which facilitate grasping to move the entire oven rotisserie 100, such as for placing it in or removing it from an oven. Front and side views of oven rotisserie 100 are illustrated in FIGS. 3 and 4. Alternatively, the drip tray suitably integrated into the oven rotisserie by being secured to a bottom of each of supports 108 and 112.

The design of the example embodiment of FIGS. 1 and 2 provides a rotisserie that can act as a tumbler for smaller food items, such as French fries, chips, or chicken nuggets. All surfaces can be intermittently exposed to hot air during the cooking process such that all surfaces are cooked fully and evenly, unlike a conventional baking operation where uneven and non-uniform cooking of individual food elements is to be expected. FIGS. 3 and 4 illustrate front and back views of the oven rotisserie of FIGS. 1 and 2.

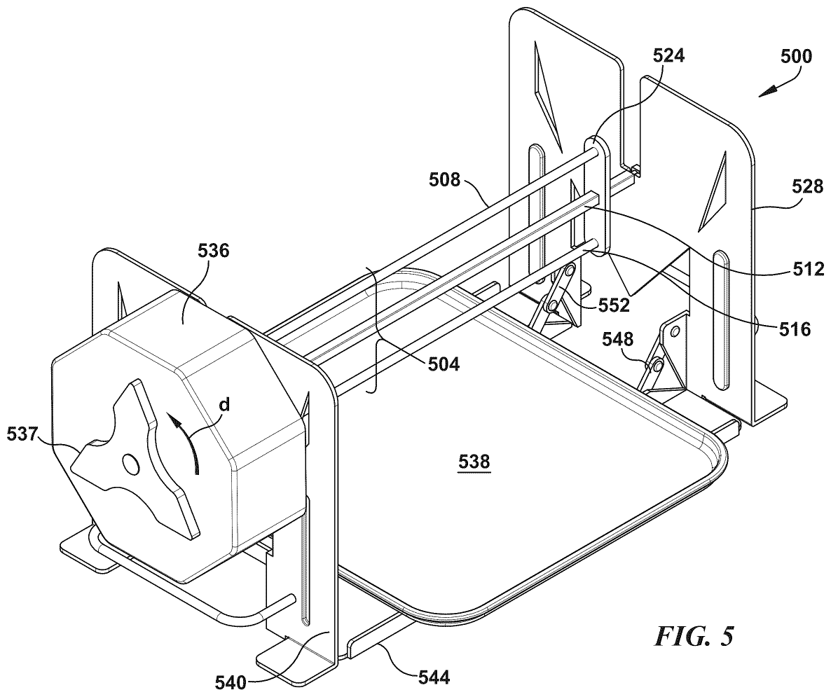

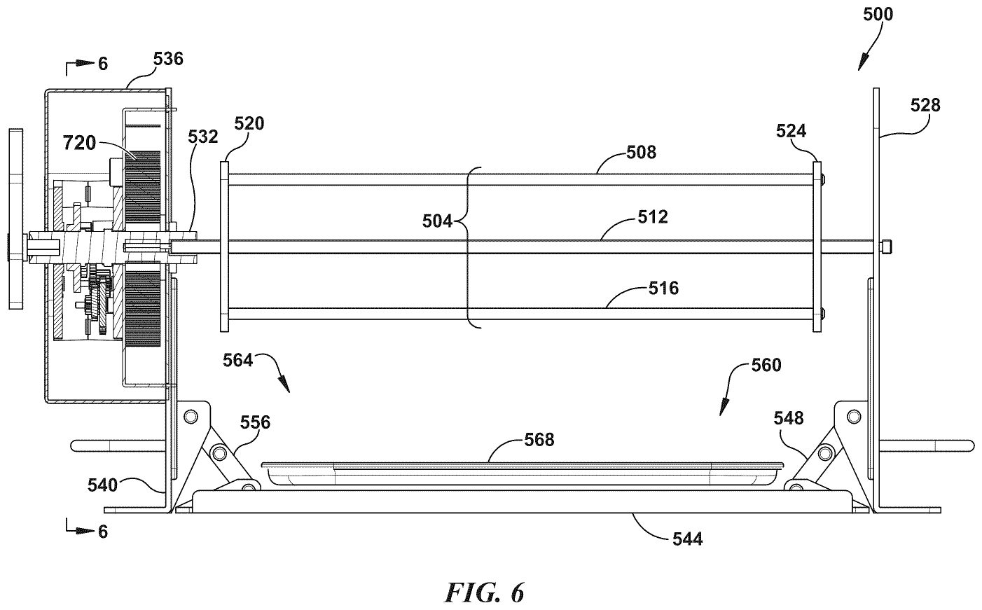

FIGS. 5 and 6 illustrate another example embodiment of an oven rotisserie 500 for rotating food, such as meat, as it is suspended by one spit 504. In the illustrated example, spit 504 is comprised of three parallel skewers 508, 512 and 516. Skewers 508 and 516 secured to be radially disposed from skewer 512 by supports 520 and 524. Skewer 512 forms a rotational axis about which skewers 508 and 516 rotate. Skewer 512 is pivotably and removably secured perpendicularly to support wall 528 at one end and removably affixed or coupled to a rotatable drive shaft 532 at the other end. Drive shaft 532 is configured to be rotated by drive mechanism or motor 536 which is supported by vertical side wall 540. Drive mechanism 536 is suitably wound by rotation of handle portion 537, such as in direction d.

Walls 528 and 540 are pivotably connected to base plate 544 such that in a first position, as illustrated, they are substantially parallel to one another. Connections between wall 528 and base plate 544 is via pivoting support brackets 548 and 552. Connection between wall 540 and base plate 544 is similarly via two pivoting support brackets mirroring support brackets 548 and 552, with bracket 556 being visible in FIG. 6. So constructed, walls 528 and 540 are foldable while collapsing or extending their associated support bracket to abut base plate 544 as indicated by directional arrows 560 and 564 when spit 504 is removed, thus allowing for more compact storage of rotisserie 500, and are lockable or maintainable in an open or a closed position. And the walls are positionable to remain in an opened or a closed position unless acted on by application of a sufficient pivot force. Drip tray 568 is suitably placed above base plate 544 and below spit 504 during a cooking operation of food supported by spit 504 so as to catch droplets, such as grease or water. Alternatively base plate 544 is itself configured as a drip tray obviating any need for a separate tray.

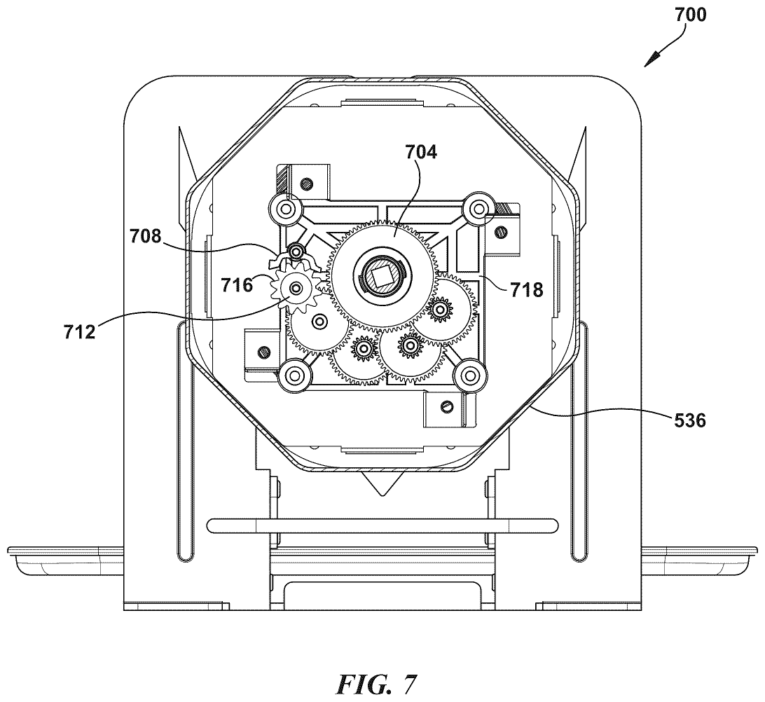

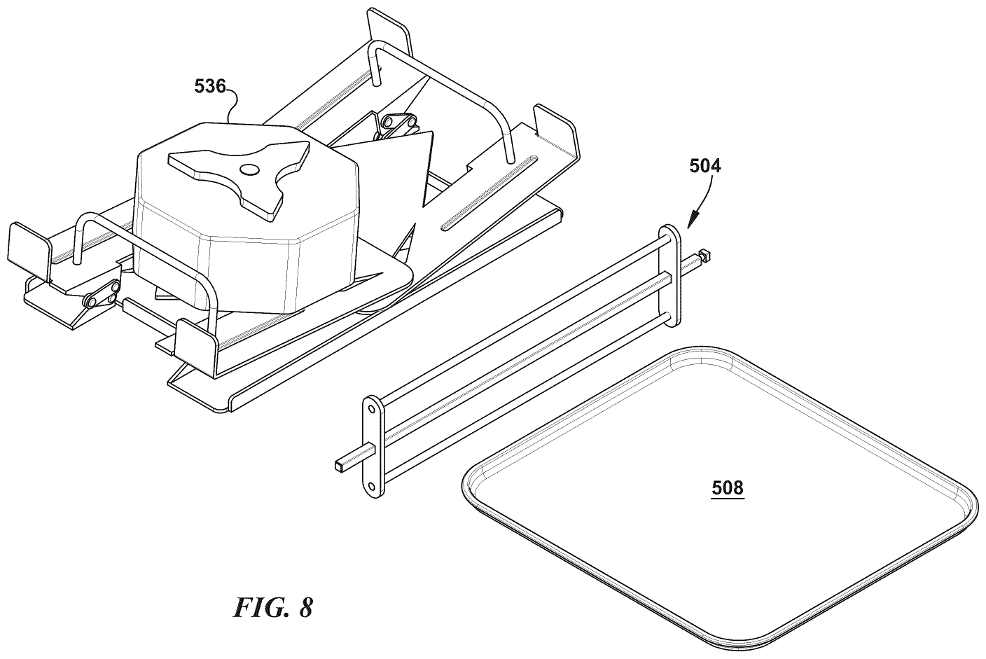

FIG. 7 is a cutaway side view of oven rotisserie 500 as taken from line 6-6 in FIG. 6. Illustrated in FIG. 7 is an example embodiment of drive motor mechanism 536, suitably comprising a mechanically powered drive system, such as a wind up spring motor selected with sufficient drive and geared for relatively slow rotation of food on spit 504, such as is well understood by one of ordinary skill in the art. An example of a drive mechanism may be found with a spring motor of a mechanical clock drive system. Any suitable user notification can be used to indicate that the spring motor must be rewound for continued food rotation during a cooking cycle. While a user may look into the oven and determine that rotation is stopped or slowing, or a user may no longer hear a clicking the escapement, an actual notification, such as by triggering any visual or audible signal may also be used. By way of example, an alarm, such as a ringing bell, is suitably generated at such point when cooking is ongoing but the drive mechanism is in need of rewinding, such as when a known time associated with a single rotation session indicates that additional winding is required to keep cooking. Spring motor may also be comprised of a spring system 704 which suitably comprises a coiled spring 720 (see e.g., FIG. 6) which may further comprise a bimetal drive mechanism, such as a bimetal coil instead of or in addition to a wind up mechanism. A suitable bimetal coil will deform when the rotisserie is placed in a heated environment, and mechanical movement induced by such deformation can impart a force to the drive mechanism.

Rotisserie rotation rate is suitably controlled by ratchet or escapement 708 acting on teeth 716 of gear 712 so as to create a rocking, periodic contact between gear teeth and escapement. Such interaction results in food rotation in stepped intervals, rather than continuous rotation. Such stepped intervals provide sufficient, regular food rotation while conserving stored motor energy. As shown in FIG. 7, the plurality of gears may be supported on a gear box frame member 718 of the drive mechanism 536.

In one or more embodiments, the oven rotisserie 500 may comprise a mechanical timer with visual feedback (without digital circuitry), such as a mechanical timer that includes (i) a clicking sound, (ii) physical countdown dials, and/or (iii) visual colored flags or indicators that rise or flip when time ends.

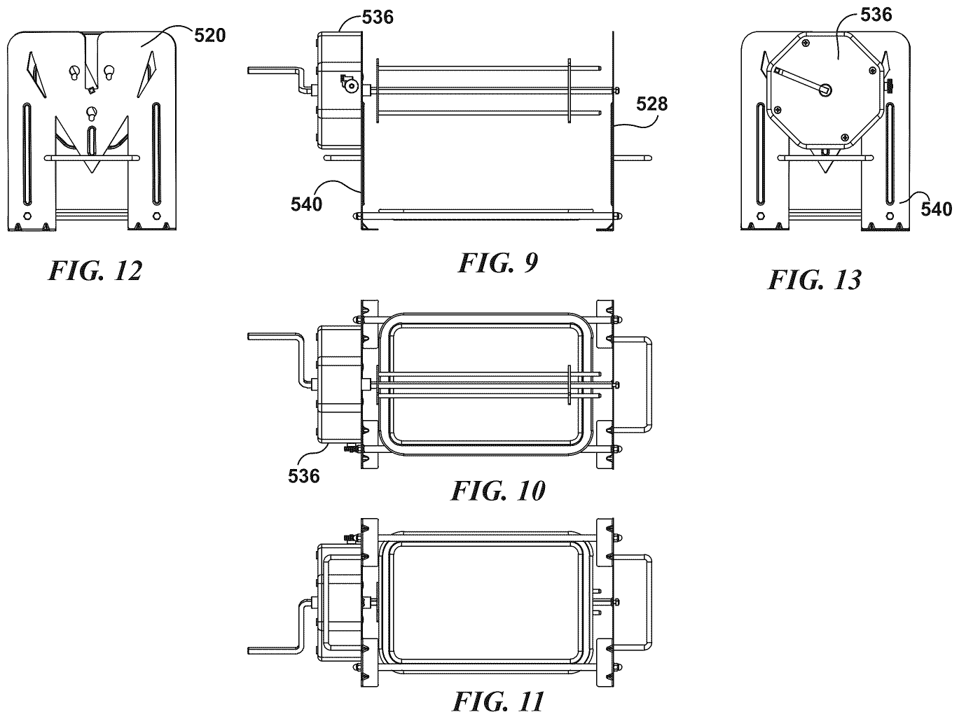

FIG. 8 is an exploded view showing spit 504, drip pan 508 and drive mechanism 536. FIGS. 9-13 illustrated side, top and bottom views of oven rotisserie 500.

Advantageously, the oven rotisserie 500 of FIG. 5 enables the interchangeability of various cooking accessories (e.g., a rotisserie skewer, a rotisserie basket, a flatspin basket, a drum, a tray, etc.) with the support walls 528, 540. The oven rotisserie 500 advantageously employs a non-electric, tool-less attachment system and foldable frame compatibility.

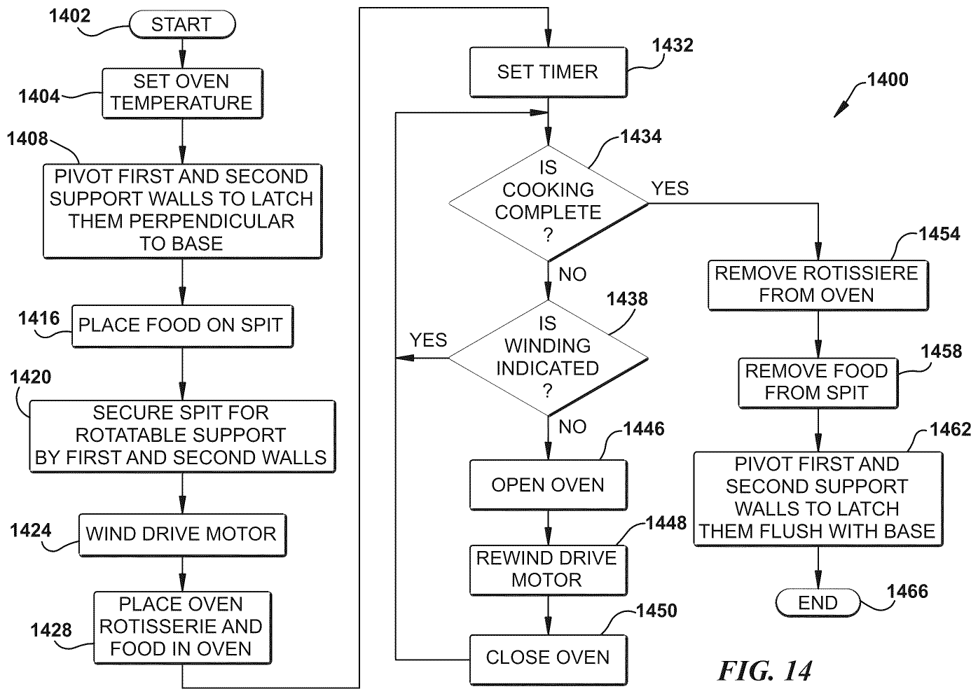

FIG. 14 is a flowchart of an example embodiment of a cooking process using an oven rotisserie system. The process commences at block 1402 and proceeds to block 1404 where a user sets an oven temperature. Next, at block 1408, the oven rotisserie is set from a storage position to a cooking position by pivoting first and second support walls to extend an associated latch mechanism to maintain their position perpendicular to a base. Food is placed on a spit at block 1416, and the spit is secured for support by the first and second walls at block 1420. A wind-up motor is wound at block 1424 and the rotisserie and mounted food are placed in an oven at block 1428. A timer is set at block 1432 and the food starts cooking. A test is made to determine if cooking is complete at block 1434. If not, a test is made at block 1438 as to whether a user notices that a rewinding is necessary, suitably triggered by a timer or other alarm. If rewinding is needed, the oven is opened at block 1446 and the motor rewound at block 1448. This may be done while the rotisserie is in the oven or it may be removed to avoid possible contact with hot oven surfaces. Rewinding may be done with any suitable heat insulated contact surface, either formed on the winding mechanism or held by the user, such as an oven mitt, towel, or the like. Once rewound and with the rotisserie in the oven, the oven door is closed at block 1450 and the process returns to block 1434. If cooking is complete as determined by block 1434, the rotisserie is removed from the oven at block 1454, and food is removed from the spit at block 1458, and the oven rotisserie is placed in storage position at block 1462 by pivoting the support walls to be flush with the base and collapse an associated latch to hold the walls and base relative to this position. If no rewinding was needed as determined by block 1438, the process returns to block 1434.

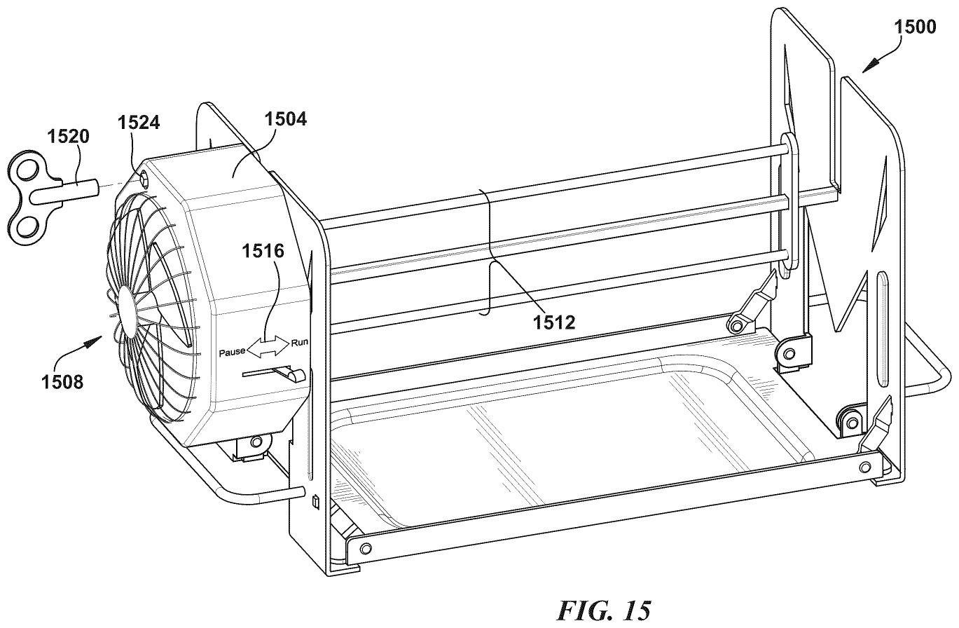

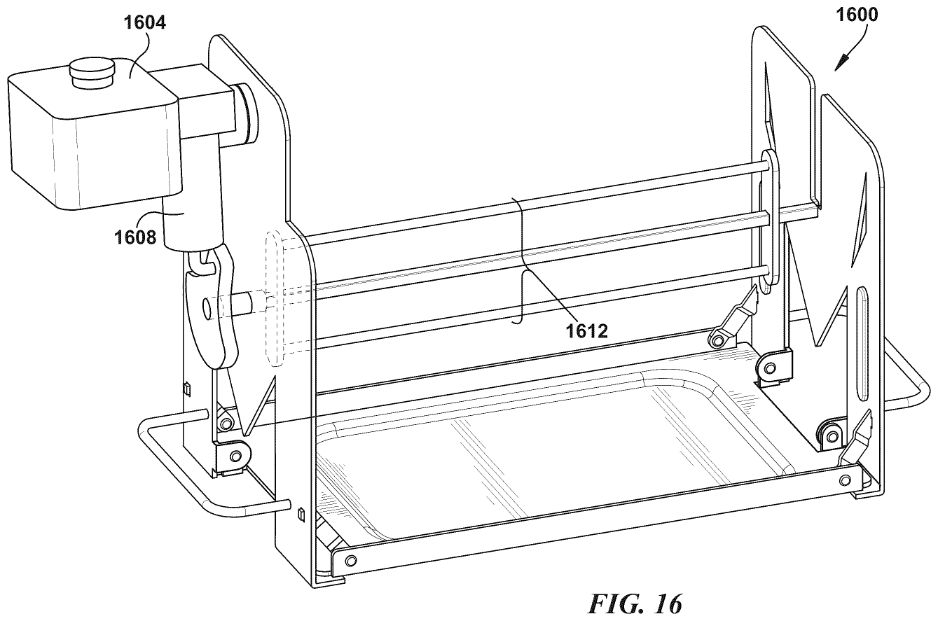

FIG. 15 illustrates another example embodiment of an oven rotisserie 1500 wherein drive mechanism or motor 1504 also powers a fan 1508 suitably geared for continuous rotation at a substantially faster rate than that of spit 1512. In this example embodiment, oven rotisserie 1500 functions to circulate oven air for convection heating of food, particularly in non-convection ovens. With convection cooking, cook times can be lessened and/or oven temperature lowered. Also baking without convection can lead to uneven browning because of hot spots in the oven.

The example embodiment of FIG. 15 also illustrates a switch 1516 that suitably stops and starts operation of drive mechanism 1504, such as when it is being loaded into or removed from an oven, thus minimizing noise and motion while in transit, while also conserving stored mechanical energy. In the example, drive mechanism 1504 is wound by a removable key 1520 operable on shaft end 1524.

FIG. 16 is another example embodiment of oven rotisserie 1600 powered by compressed gas or steam. Reservoir 1604 is suitably filled with compressed air, such as via a pump or CO2 canister. Pressure from reservoir 1604 is suitably used to power drive mechanism or motor 1608 to rotate spit 1612. Alternatively, reservoir 1604 may be filled with water. Once oven rotisserie 1600 is placed in an oven, typically set well above the boiling point of water. When heated, water in reservoir 1604 turns to steam to power drive mechanism 1608. Release of steam after use in powering rotation of spit 1612 can also advantageously add moisture, and even steam cooking, to an oven interior and exposed food. Steam can assist in heating the food while simultaneously keeping moister both internally and along food surfaces.

Many foods for which oven cooking is desired are not suitably rotated by the example embodiments above. This may include fresh or frozen foods that require oven cooking one or more of the oven cooking modes detailed above that have a generally planar surface. Examples of such foods include:

Pizza: A flat, round bread that is typically topped with tomato sauce, cheese, and various meats, vegetables, and herbs. It is often cooked in a wood-fired oven, which gives it a crispy crust and a smoky flavor. Pizza can be found in many different variations and styles, from Neapolitan to Chicago deep-dish to New York-style pizza.

Focaccia: A type of Italian bread that is similar to pizza dough, but typically thicker and more fluffy. It is often topped with herbs, cheese, and other ingredients.

Tarte flambée: A thin, crispy flatbread that is a specialty of the Alsace region in France. It is typically topped with onions, bacon, and cream.

Galette: A French pastry that is made with a thin layer of dough and filled with sweet or savory ingredients, such as fruit, cheese, or vegetables. It can be round or rectangular in shape, depending on how it is folded or cut.

Socca: A type of flatbread that is made from chickpea flour and water. It is a specialty of the south of France and is typically served with toppings such as olive oil, herbs, and black pepper.

Calzone: A type of folded pizza that is filled with cheese, meats, and other ingredients. It is typically baked until golden brown and served hot.

Quiche: A French dish that is made with a pastry crust and filled with eggs, cheese, meats, and vegetables. It can be round or rectangular in shape, depending on the size of the baking dish.

Frittata: An Italian dish that is similar to a crustless quiche. It is made with eggs, cheese, and vegetables or meats and can be served hot or cold.

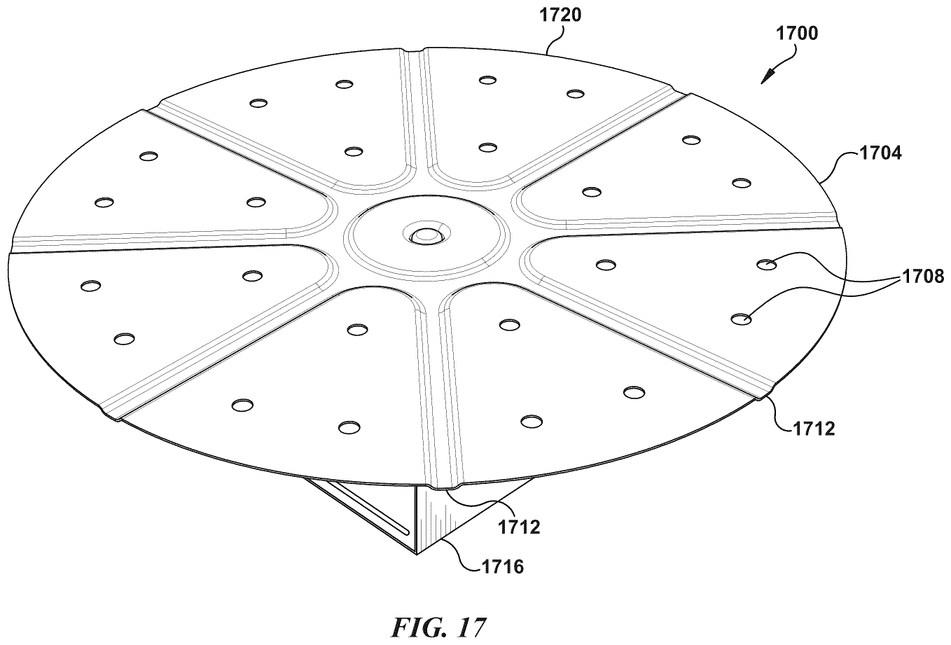

FIG. 17 is a perspective view of an example embodiment of a system 1700 for rotating flat foods, such as those noted above, in a fashion using a manually wound drive motor configuration such as described above. Included is a substantially planer support surface 1704 constructed from any material suitable to withstand oven temperatures. This includes metals that conduct heat well, have good thermal stability and are safe for food use are generally used for oven cookware. Some examples of metals that are suitably used for oven cookware are:

Stainless steel: It is durable, corrosion-resistant, and can withstand high temperatures. Stainless steel cookware is often used for roasting and baking.

Cast iron: It is known for its excellent heat retention and can withstand high temperatures. Cast iron cookware is often used for baking and roasting.

Aluminum: It is an excellent conductor of heat and can be used to make lightweight and durable cookware. Aluminum cookware is often used for baking and roasting.

Copper: It is an excellent conductor of heat and has good thermal stability. Copper cookware is often used for baking and roasting.

In the example embodiment of FIG. 17, support surface 1704 is comprised of aluminum and is perforate via a plurality of vent holes 1708. The vent holes facilitate heat transfer and minimize moisture buildup, particularly useful when used with frozen foods. Thinner aluminum is suitably used to lessen manufacturing costs. Support ribs, such as radially extending support ribs 1712 allow for mainlining surface rigidity with thinner material. Further reduction in material used and weight is associated with use of the vent holes. Support plate 1704 is mechanically connected to a mechanical drive motor disposed in base 1716 at a top end of a motor shaft, suitably secured at a center 1720 of support plate 1704.

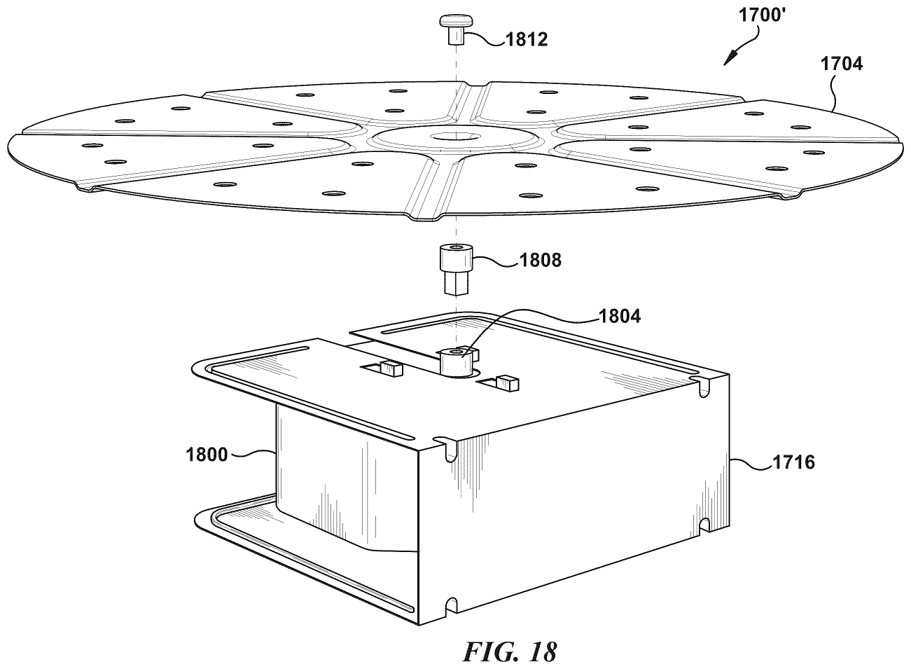

FIG. 18 is an exploded view 1700′ of the system 1700 of FIG. 17. Drive motor 1800 is disposed within base 1716 such that a top end 1804 of its drive shaft extends vertically upward. Top end 1804 is removably secured to the center of support plate 1704 to impart rotation. In the illustrated example, this is accomplished with adapter 1808, configured for keyed connection with a corresponding mating portion in drive shaft 1804. Adapter 1808 is disposed to a bottom center of support plate 1704 and selectably secured via fastener 1812.

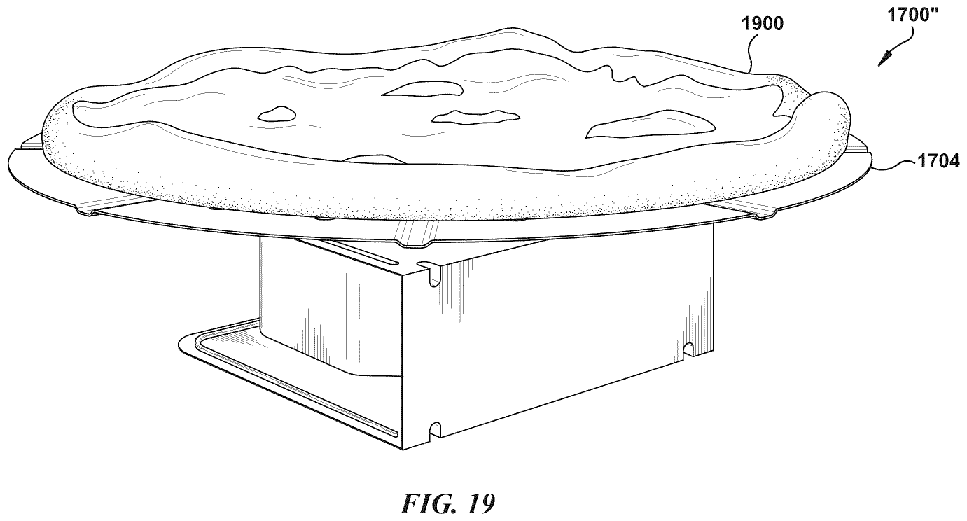

FIG. 19 illustrates an example embodiment 1700″ of the system 1700 of FIG. 17. Food, such as pizza 1900 is placed on support plate 1704 such that the mechanism may be wound and placed in an oven for cooking.

There are certain foods wherein cooking while being supported by the above embodiments is disadvantageous or undesirable. This includes foods for which vertical cooking is desired.

### Example Foods that are Best Cooked Vertically on a Skewer or Spit Include

Kebabs: Kebabs are traditionally cooked vertically on a skewer or spit. This cooking method ensures even cooking and allows excess fat to drip away, resulting in a leaner and healthier dish.

Shawarma: Shawarma is a Middle Eastern dish that is typically made from marinated meat that is cooked on a spit and sliced thinly. Cooking the meat vertically allows it to cook evenly and gives it a crispy exterior.

Rotisserie Chicken: Rotisserie chicken is another dish that is typically cooked on a spit. Cooking the chicken vertically allows the juices to drip away, resulting in a crispy skin and juicy meat.

Gyro: Gyro is a Greek dish that is typically made from meat that is cooked on a vertical spit and sliced thinly. This cooking method allows the meat to cook evenly and gives it a crispy exterior.

Pork Roast: A pork roast can also be cooked vertically on a spit. This cooking method allows the pork to cook evenly and gives it a crispy exterior.

Cooking foods vertically is a traditional cooking method that is used in many cultures, and it can be a great way to cook a variety of dishes. In the embodiment of FIGS. 17-19, the mechanical drive motor 1800 is provided on the bottom, intended to rotate items like pizza, bread (e.g., flatbread), or other baked items that make sense with a flat support plate 1704. Also, the vertical rotation configuration of the mechanical drive motor 1800 could be used with pizza stones, steel trays, display trays, serving trays, rotating pottery bases, jewelry polishing stands, etc. where vertical rotation of a flat tray is useful.

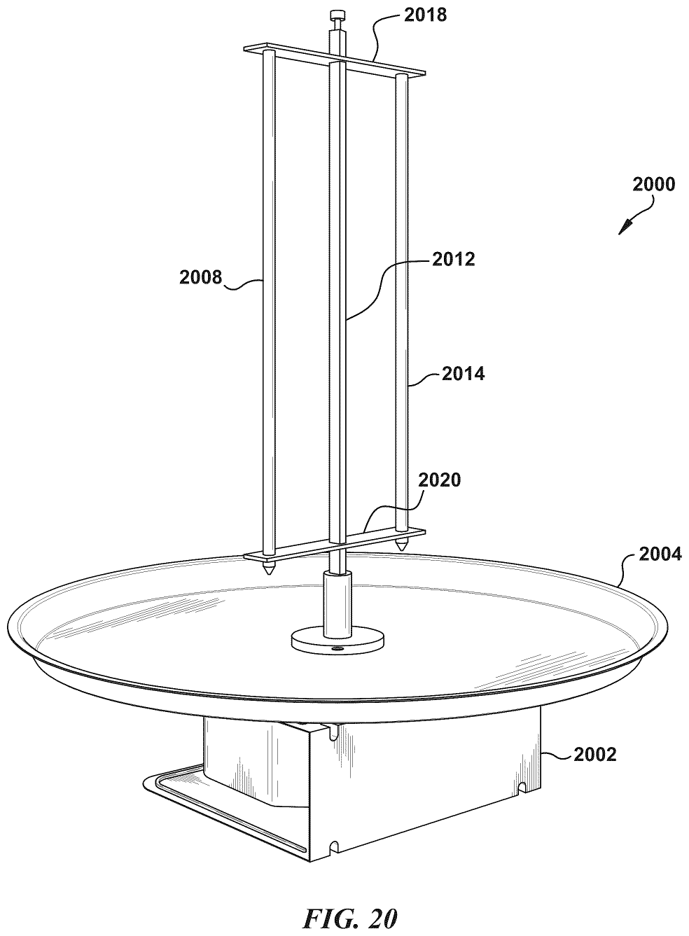

FIG. 20 is a perspective view of a system 2000 for rotating vertically oriented foods while being cooked in an oven. Included is motorized base 2006, suitably analogous to that described above. Base 2002 supports a rounded drip plate 2004 via mechanical connection with an upward end of a vertically oriented drive shaft of a drive motor in base 2002. Skewers 2008, 2012 and 2014 are rotated by a vertically oriented drive motor disposed in base 2002, analogously to the system of FIGS. 17-19, above. The same base may be suitably used for both planar and vertically oriented foods. In the example embodiment of FIG. 20, skewer 2012 is mechanically connected to the drive motor and rotates with skewers 2008 and 2014 via supports 2018 and 2020.

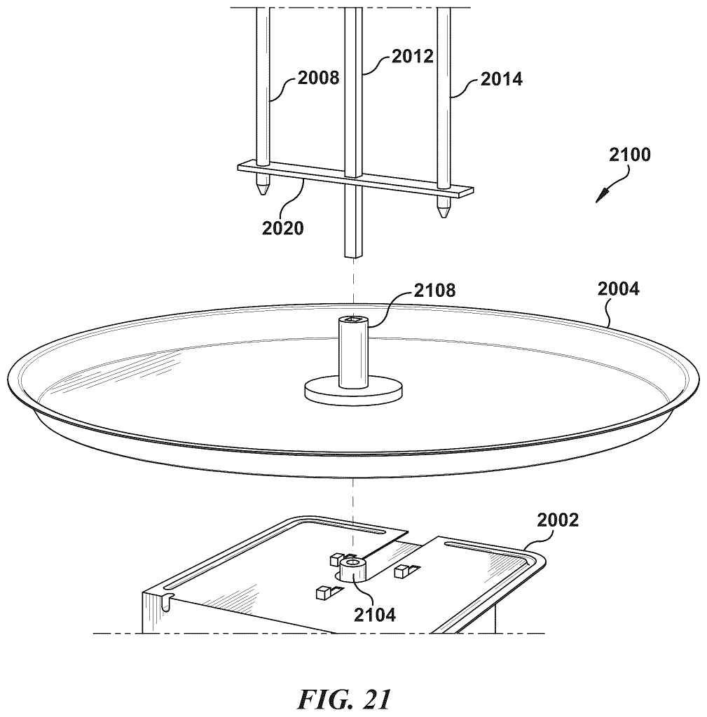

FIG. 21 is an exploded view 2100 of a bottom portion of system 2000 of FIG. 20. A top end 2104 of the drive motor is keyed for mechanical connection to rotate drip tray 2004 and skewers 2008, 2012 and 2014 via a keyed connection to adapter 2018, such that the skewers, drip tray and skewers may be dissembled, such as for cleaning and storage.

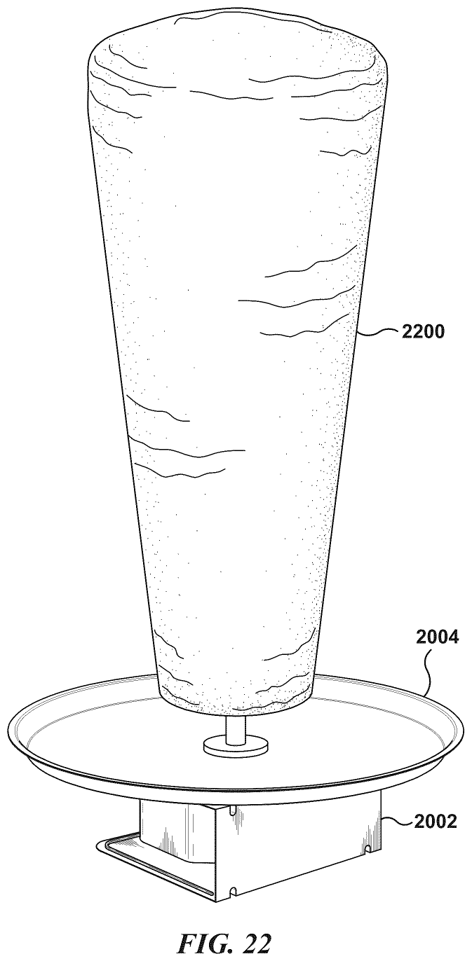

FIG. 22 is a perspective view of the system of FIGS. 20 and 21 illustrating skewered kebob 2200 oriented for cooking.

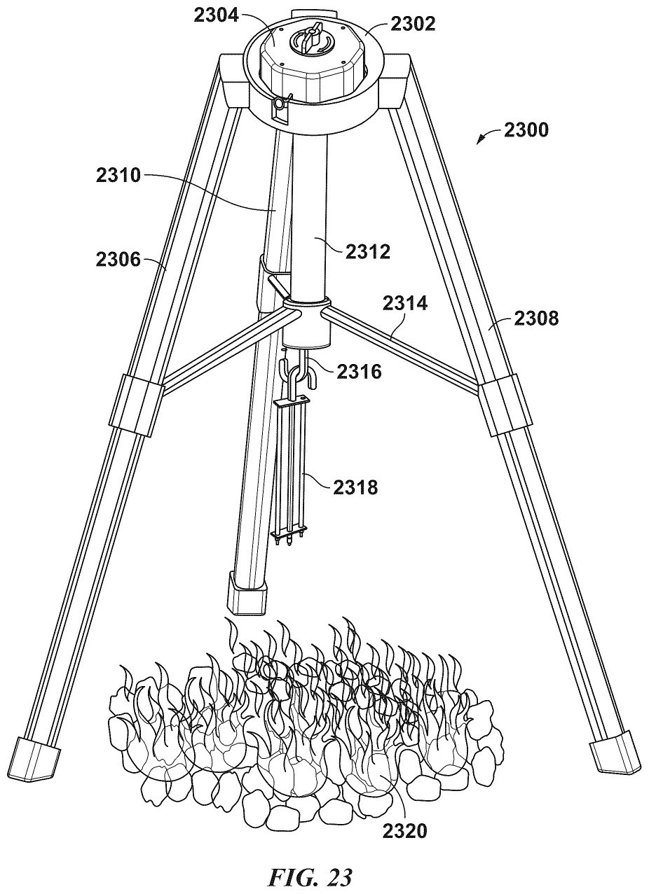

In the example embodiment of FIG. 23, the vertical self-powered food rotational system 2300 has the mechanical drive motor 2304 positioned on top, designed to rotate food while it spins vertically with heat applied from the bottom or side, which is ideal for skewers, shawarma, or other rotisserie-style cooking. In FIG. 23, it can be seen that the support assembly of the system 2300 comprises a base that includes a top base support 2302 and a plurality of base legs 2306, 2308, 2310 extending downwardly from the top base support 2302. In this embodiment, the mechanical drive motor 2304 is supported in a recess of the top base support 2302, and the mechanical drive motor 2304 includes a rotatable center shaft 2312 disposed in a substantially vertical orientation (see FIG. 23). Also, as shown in FIG. 23, the food rotational member comprises a removable vertically-oriented spit 2318 (i.e., a 3-prong rotisserie rod 2318) operatively linked to a bottom end of the rotatable shaft 2312 of the mechanical drive motor 2304 such that food supported on the vertically-oriented spit 2318 is capable of being rotatably suspended over an open fire 2320. In FIG. 23, it can be seen that the vertically-oriented spit 2318 is removably connected to a bottom end of the rotatable shaft 2312 by a hook member 2316.

In the embodiment of FIG. 23, it can be seen that the base of the system 2300 is in a form of a tripod base with the top base support 2302 and first, second and third tripod base legs 2306, 2308, 2310 extending downwardly from the top base support 2302. Also, as shown in FIG. 23, the bottom end of the rotatable shaft 2312 is laterally supported by the bottom support member 2314, which is connected to each of the three (3) tripod base legs 2306, 2308, 2310. The multi-legged stand of FIG. 23 with the mechanical drive motor 2304 mounted on the top is particularly useful for vertical rotation of skewered meat (e.g., shawarma, al pastor, etc.).

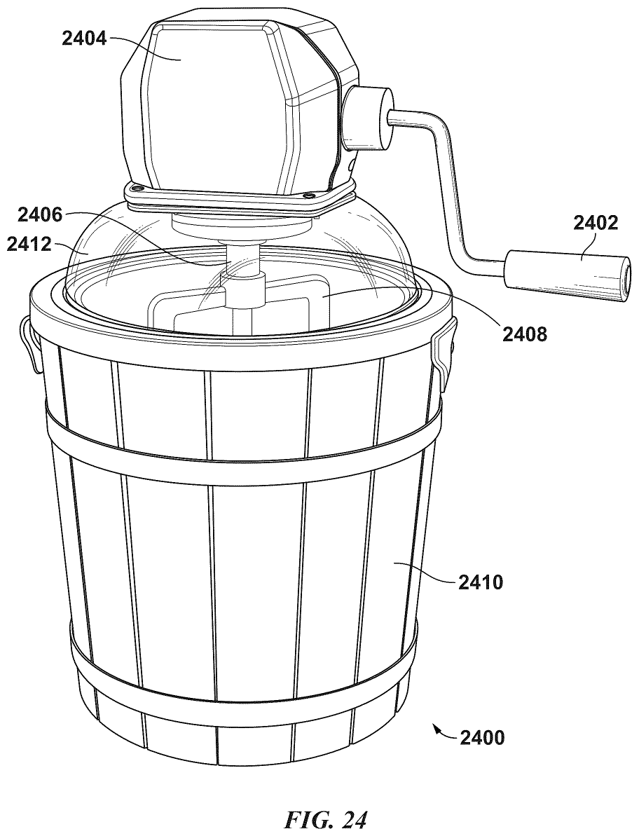

In the example embodiment of FIG. 24, the vertical self-powered food rotational system 2400 is in a form of an ice cream maker utilizing a mechanical drive motor 2404. In FIG. 24, it can be seen that the support assembly of the system 2400 comprises a base that includes bucket-like insulated housing 2410 and a clear top cover 2412. In this embodiment, the mechanical drive motor 2404 is supported on the clear top cover 2412, and the mechanical drive motor 2404 includes a rotatable shaft 2406 disposed in a substantially vertical orientation (see FIG. 24). Also, as shown in FIG. 24, the food rotational member of the system 2400 comprises a vertically-oriented agitator member 2408. The vertically-oriented agitator member 2408 is operatively linked to a bottom end of the rotatable shaft 2406 of the mechanical drive motor 2404 such that the vertically-oriented agitator member 2408 is capable of mixing and/or churning ice cream in the insulated housing 2410 of the base.

Also, as shown in the embodiment of FIG. 23, it can be seen that the ice cream maker 2400 further comprises a handle member 2402 for rewinding the mechanical drive motor 2404. In some embodiments, the handle member 2402 could also be used for manually rotating the vertically-oriented agitator member 2408 of the ice cream maker 2400. Advantageously, by using the mechanical drive motor 2404, the ice cream maker 2400 is capable of churning ice cream without the requirement for electricity.

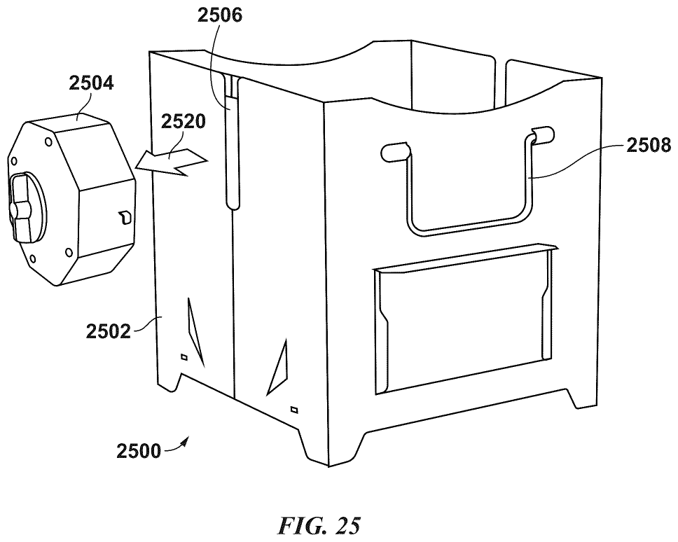

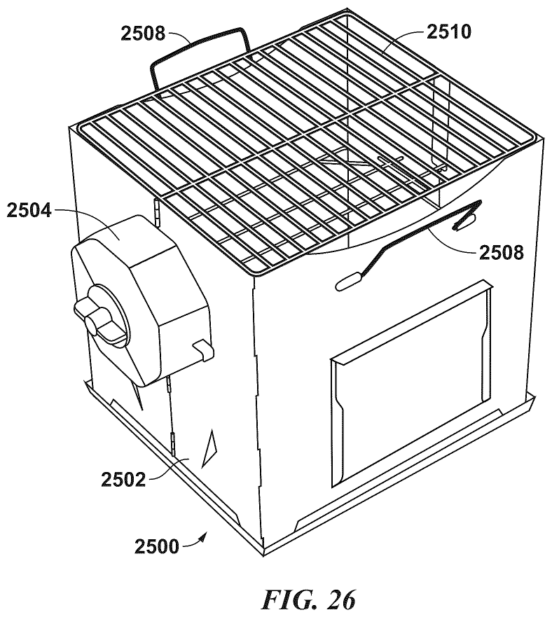

In the example embodiment of FIGS. 25-32, the self-powered food rotational system 2500 is in a form of a foldable grill assembly. In FIG. 25, it can be seen that the foldable grill assembly 2500 comprises a foldable grill housing 2502 with a mechanical drive motor 2504 configured to be mounted on a side of the foldable grill housing 2502. Advantageously, the mechanical drive motor 2504, like the mechanical drive motors 132, 536, 1504, 1800, 2304, 2404, described above, is configured to be powered by a manually wound spring so that no electricity is needed for operating the foldable grill assembly 2500. In FIG. 25, the side directional arrow 2520 is pointing in the motor removal direction, but it is to be understood that the motor attachment direction of the mechanical drive motor 2504 is opposite to the motor removal direction. As shown in FIGS. 25 and 26, the foldable grill housing 2502 comprises handle members 2508 attached to oppositely disposed sides of the foldable grill housing 2502 so that the foldable grill assembly can be easily carried by a user thereof. Advantageously, the components of the foldable grill assembly can be detached from the foldable grill housing 2502, and the foldable grill housing 2502 can be folded into a collapsed position so that the foldable grill assembly can be compactly stored.

Turning to FIG. 26, it can be seen that the foldable grill assembly 2500 may further comprise a grilling rack 2510 that is configured to be disposed above the food support, which is rotated by the mechanical drive motor 2504.

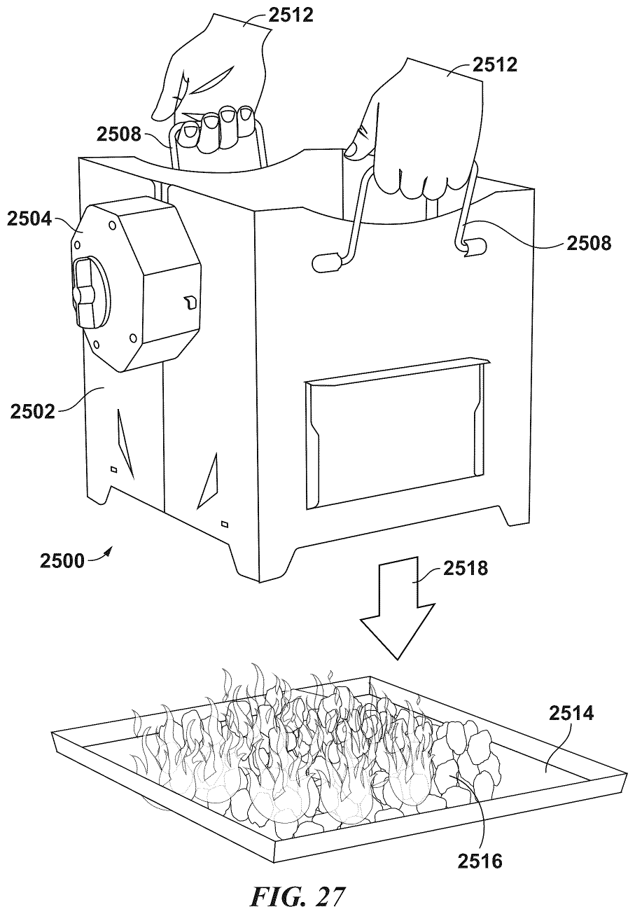

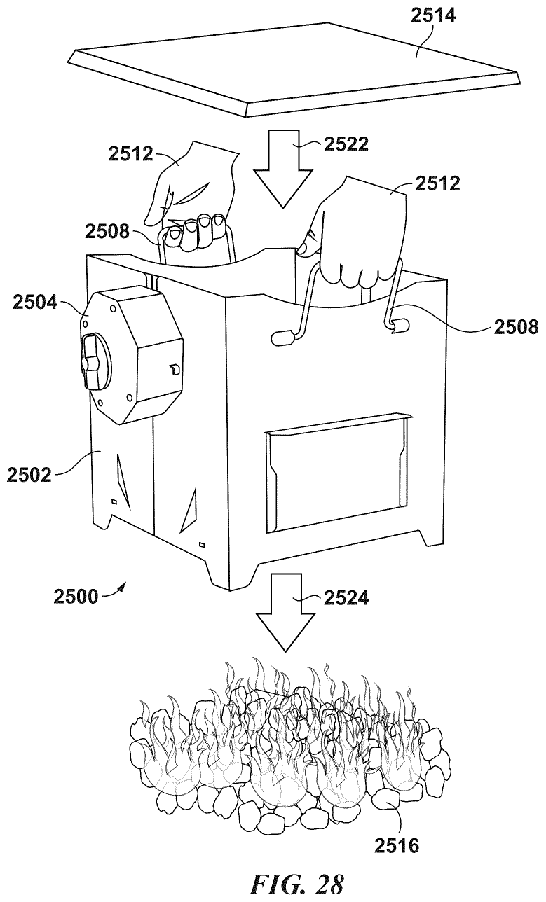

A first use configuration of the foldable grill assembly 2500 is depicted in FIG. 27. In FIG. 27, the foldable grill housing 2502 may be supported on a base plate member 2514, which forms a tray for supporting charcoal 2516. As shown in FIG. 27, by grasping the handle members 2508 on the oppositely disposed sides of the foldable grill housing 2502 with his or her hands 2512, a user may place the foldable grill housing 2502 on the top surface of the base plate member 2514 so that a food item inside the foldable grill assembly 2500 may be grilled. In FIG. 27, the lowering of the foldable grill housing 2502 onto the top of the base plate member 2514 is diagrammatically represented by the downward directional arrow 2518. A second use configuration of the foldable grill assembly 2500 is depicted in FIG. 28. In FIG. 28, the foldable grill housing 2502 may be disposed over an open fire with charcoal 2516. As shown in FIG. 28, by grasping the handle members 2508 on the oppositely disposed sides of the foldable grill housing 2502 with his or her hands 2512, a user may place the foldable grill housing 2502 over the fire with charcoal 2516 so that a food item inside the foldable grill assembly 2500 may be grilled. In FIG. 28, the lowering of the foldable grill housing 2502 onto the fire with charcoal 2516 is diagrammatically represented by the downward directional arrow 2524. In FIG. 28, in order to trap the heat generated by the fire inside the foldable grill housing 2502, the plate member 2514 may be placed over the top of the foldable grill housing 2502, as diagrammatically represented by the downward directional arrow 2522.

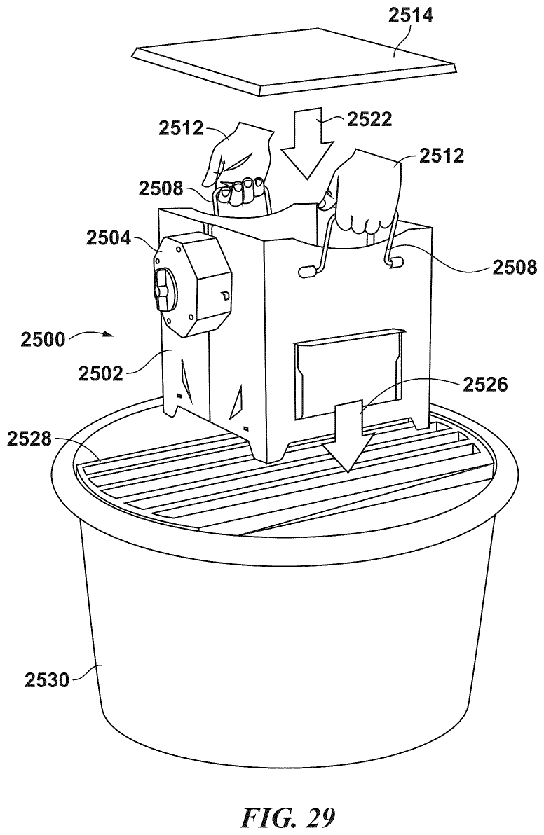

A third use configuration of the foldable grill assembly 2500 is depicted in FIG. 29. In FIG. 29, the foldable grill housing 2502 may be placed on a grate 2528 of a portable grill 2530. As shown in FIG. 29, by grasping the handle members 2508 on the oppositely disposed sides of the foldable grill housing 2502 with his or her hands 2512, a user may place the foldable grill housing 2502 on the grate 2528 of the portable grill 2530 so that a food item inside the foldable grill assembly 2500 may be grilled. In FIG. 29, the lowering of the foldable grill housing 2502 onto the grate 2528 of the portable grill 2530 is diagrammatically represented by the downward directional arrow 2526. In FIG. 29, in order to trap the heat generated by the fire inside the foldable grill housing 2502, the plate member 2514 may be placed over the top of the foldable grill housing 2502, as diagrammatically represented by the downward directional arrow 2522.

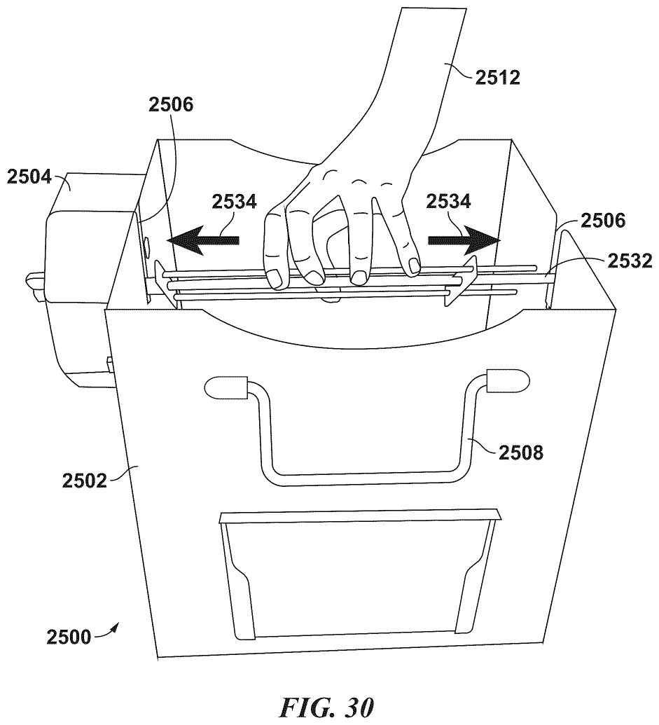

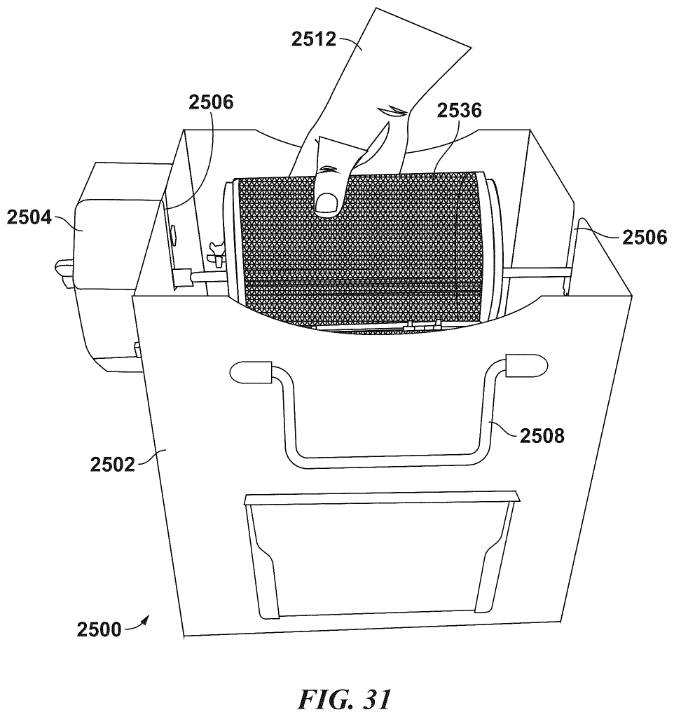

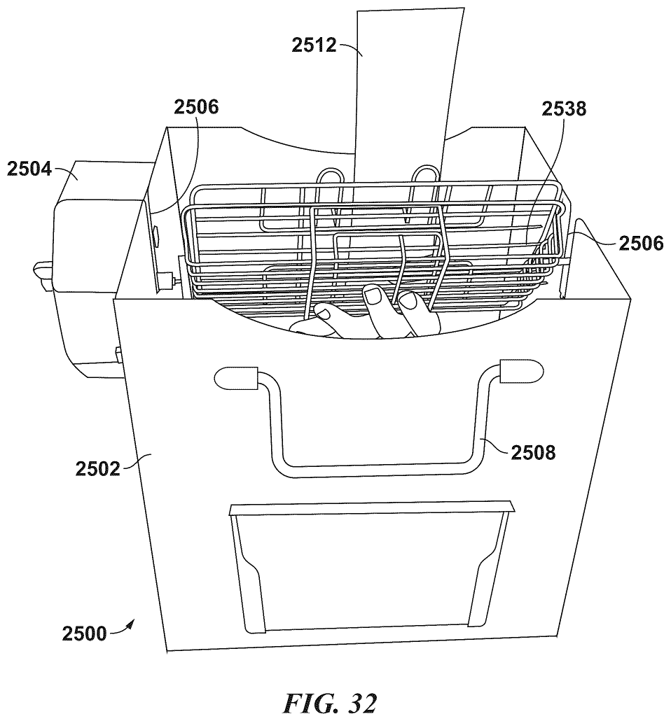

Referring to FIGS. 30-32, the interchangeability of the food supports 2532, 2536, 2538 within the foldable grill assembly 2500 will be explained. Advantageously, a user may choose his or her desired food support (i.e., rotisserie attachment 2532, 2536, 2538), and removably secure the attachment 2532, 2536, 2538 in place in the foldable grill housing 2502. Initially, as shown in FIG. 30, a spit 2532 (i.e., a rotisserie skewer 2532) may be removably coupled to the mechanical drive motor 2504, and then removably secured in place within the opposed elongate slots 2506 of the foldable grill housing 2502 (as diagrammatically indicated by the outwardly pointing side directional arrows 2534 in FIG. 30). Alternatively, as shown in FIG. 31, a rotisserie basket 2536 may be removably coupled to the mechanical drive motor 2504, and then removably secured in place within the opposed elongate slots 2506 of the foldable grill housing 2502. Yet alternatively, as shown in FIG. 32, a flatspin basket 2538 may be removably coupled to the mechanical drive motor 2504, and then removably secured in place within the opposed elongate slots 2506 of the foldable grill housing 2502.

All of the different configurations of the self-powered food rotational system explained above utilize a non-electric drive system and utilize either a generally horizontal rotational axis or a generally vertical rotational axis in either rotational hot or cold applications. These applications demonstrate the versatility of the self-powered food rotational system in hot cooking applications, cold cooking applications, and non-cooking applications. In some embodiments, the self-powered food rotational system may comprise a universal mount adaptable for both thermal and chilled use cases.

Any of the features or attributes of the above described embodiments and variations can be used in combination with any of the other features and attributes of the above described embodiments and variations as desired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

The invention claimed is:

1. A self-powered food rotational system, comprising:
a support assembly;
a food rotational member having a rotational axis, the food rotational member configured to rotate an associated food item;
a mechanical drive motor operatively coupled to one end of the food rotational member, the mechanical drive motor configured to impart a rotational force to the food rotational member via a gear; and
the mechanical drive motor configured to be powered by a manually wound spring.

2. The system according to claim 1, wherein the support assembly comprises a first support and a second support, and the food rotational member is pivotably secured between the first support and the second support.

3. The system according to claim 2, further comprising a horizontal base pivotally connected to the first and second supports at opposite ends configured such that both the first and second supports are inwardly foldable toward one another.

4. The system according to claim 2, wherein the food rotational member comprises a food support in a form of a removable spit pivotably secured to the first and second supports at distal ends thereof.

5. The system according to claim 4, wherein the spit is comprised of two or more parallel skewers.

6. The system according to claim 2, further comprising a drip tray disposed between the first support and the second support.

7. The system according to claim 1, wherein the food rotational member comprises a food support that includes a cylindrical cage pivotably secured to the first and second supports.

8. The system according to claim 7, wherein the food support further comprises oppositely disposed perforate end panels.

9. The system according to claim 7, wherein the food support further comprises a latchable door.

10. The system according to claim 1, wherein the support assembly comprises a base for containing the mechanical drive motor, the mechanical drive motor including a rotatable shaft disposed in a substantially vertical orientation; and
wherein the food rotational member comprises a rotatable, substantially planar horizontal food support mechanically linked to a top end of the rotatable shaft of the mechanical drive motor.

11. The system according to claim 10, wherein the rotatable, substantially planar horizontal food support comprises a round, planar surface in contact with the rotatable shaft at a center thereof.

12. The system according to claim 10, wherein the rotatable, substantially planar horizontal food support is further configured to be selectively removable from the rotatable shaft of the mechanical drive motor; and
wherein the rotatable, substantially planar horizontal food support is perforate.

13. The system according to claim 1, wherein the support assembly comprises a base for containing the mechanical drive motor, the mechanical drive motor including a rotatable shaft disposed in a substantially vertical orientation; and
wherein the food rotational member comprises a removable vertically-oriented spit pivotably mechanically linked to a top end of the rotatable shaft of the mechanical drive motor.

14. The system according to claim 13, wherein the vertically-oriented spit is comprised of two or more parallel skewers.

15. The system according to claim 1, wherein the support assembly comprises a base that includes a top base support and a plurality of base legs extending from the top base support, the mechanical drive motor configured to be supported in or on the top base support, and the mechanical drive motor including a rotatable shaft disposed in a substantially vertical orientation; and
wherein the food rotational member comprises a removable vertically-oriented spit operatively linked to a bottom end of the rotatable shaft of the mechanical drive motor such that food supported on the vertically-oriented spit is capable of being rotatably suspended over an open fire.

16. The system according to claim 1, wherein the support assembly comprises a base that includes an insulated housing and a top cover, the mechanical drive motor configured to be supported in or on the top cover, and the mechanical drive motor including a rotatable shaft disposed in a substantially vertical orientation; and
wherein the food rotational member comprises a vertically-oriented agitator member, the vertically-oriented agitator member being operatively linked to a bottom end of the rotatable shaft of the mechanical drive motor such that the vertically-oriented agitator member is capable of churning ice cream in the insulated housing of the base.

17. The system according to claim 1, wherein the mechanical drive motor is in a form of a heat tolerant mechanical drive motor with an audible output for alerting a user to rewind the mechanical drive motor.

18. A self-powered food rotational system, comprising:
a first support;
a second support;
a food support having a rotational axis pivotably secured between the first support and the second support, the food support configured to rotate an associated food item;
a heat tolerant mechanical drive motor operatively coupled to one end of the food support, the mechanical drive motor configured to impart rotational force to the food support via a gear; and
the drive motor configured to be powered by a manually wound spring.

19. The system according to claim 18, wherein the first support and the second support form oppositely disposed sides of a foldable grill assembly, and
wherein the foldable grill assembly further comprises a plate member or grilling rack configured to be disposed above the food support.

20. The system according to claim 18, wherein the first support and the second support form oppositely disposed sides of a foldable grill assembly, and
wherein the foldable grill assembly further comprises a plate member configured to be disposed below the oppositely disposed sides of the foldable grill assembly so as to form a base plate for supporting charcoal.
